(19) United States
(12) Patent Application Publication
(10) Pub. No.: US 2021/0220860 A1
(43) Pub. Date: Jul. 22, 2021

(54) Sprinkler Body Removal And Installation Device

(71) Applicant: Fred C. Aviguetero, JR., Koloa, HI (US)

(72) Inventor: Fred C. Aviguetero, JR., Koloa, HI (US)

(21) Appl. No.: 17/225,494

(22) Filed: Apr. 8, 2021

Related U.S. Application Data
(63) Continuation-in-part of application No. 16/574,955, filed on Sep. 18, 2019.

(51) Int. Cl. B05B 15/65; B25B 13/50; B25B 23/00

(52) U.S. Cl. CPC B05B 15/65; B25B 23/0035; B25B 13/50

(57) ABSTRACT

A sprinkler body removal and installation device for sprinkler body repair and replacement includes a pipe that has a first endpoint, which is closed, and a second endpoint that is open. The pipe has an outer diameter that is complementary to a diameter of a set of furrows that is positioned on an inner face of a bottom of a sprinkler body. Each of a plurality of cogs is coupled to and extends from the second endpoint of the pipe is configured to be inserted into a respective furrow of the set of furrows as the pipe is inserted into the sprinkler body. A cutout that is centrally positioned in the first endpoint of the pipe is configured for insertion of an extension drive of a socket wrench, positioning a user to selectively turn the socket wrench to remove and install the sprinkler body.

### CROSS-REFERENCE TO RELATED APPLICATIONS

This application is a continuation in part of application Ser. No. 16/574,955 filed on Sep. 18, 2019.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to removal and installation devices and more particularly pertains to a new removal and installation device for sprinkler body repair and replacement. The present invention discloses a removal and installation device comprising a pipe which has one end configured to engage an extension drive of a socket wrench and the other end configured to engage furrows positioned on an inner face of a bottom of a sprinkler body.

### (2) Description of Related Art including information disclosed under 37 CFR 1.97 and 1.98

The prior art relates to removal and installation devices and more particularly pertain to a new removal and installation device for a sprinkler body. Prior art removal and installation devices may comprise devices for removing sprinkler assemblies intact and rely on engagement of the devices to an exterior surface of the sprinkler assembly. Prior art removal and installation devices also may comprise devices that engage ribs positioned on interior walls of the sprinkler body, and which therefore would not be useful in the removal and installation of sprinkler bodies that are smooth walled. What is lacking in the prior art is a removal and installation device comprising a pipe which has one end configured to engage an extension drive of a socket wrench and the other end configured to engage furrows positioned on an inner face of a bottom of a sprinkler body.

### BRIEF SUMMARY OF THE INVENTION

An embodiment of the disclosure meets the needs presented above by generally comprising a pipe that has a first endpoint, which is closed, and a second endpoint that is open. The pipe has an outer diameter that is complementary to a diameter of a set of furrows that is positioned on an inner face of a bottom of a sprinkler body. Each of a plurality of cogs is coupled to and extends from the second endpoint of the pipe and is configured to be inserted into a respective furrow of the set of furrows as the pipe is inserted into the sprinkler body. A cutout is centrally positioned in the first endpoint of the pipe and is configured for insertion of an extension drive of a socket wrench, positioning a user to selectively turn the socket wrench to remove and install the sprinkler body.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric perspective view of a sprinkler body removal and installation device according to an embodiment of the disclosure.

FIG. 2 is a bottom isometric perspective view of an embodiment of the disclosure.

FIG. 3 a bottom isometric perspective of an embodiment of the disclosure.

FIG. 4 is a bottom view of an embodiment of the disclosure.

FIG. 5 is a bottom view of an embodiment of the disclosure.

FIG. 6 is a cross-sectional view of an embodiment of the disclosure.

FIG. 7 is a cross-sectional view of an embodiment of the disclosure.

FIG. 8 is an in-use view of an embodiment of the disclosure.

FIG. 9 is an in-use view of an embodiment of the disclosure.

FIG. 10 is an in-use view of an embodiment of the disclosure.

FIG. 11 is an in-use view of an embodiment of the disclosure.

FIG. 12 is a flow diagram for a method utilizing an embodiment of the disclosure.

### DETAILED DESCRIPTION OF THE INVENTION

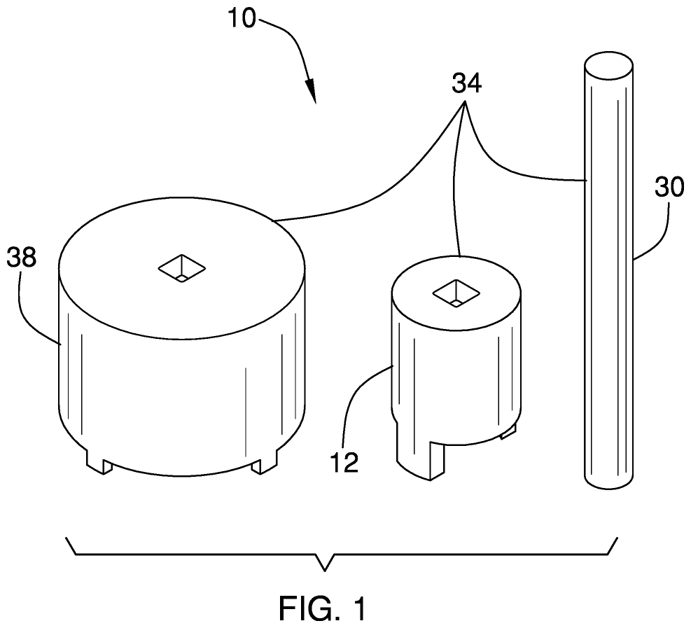

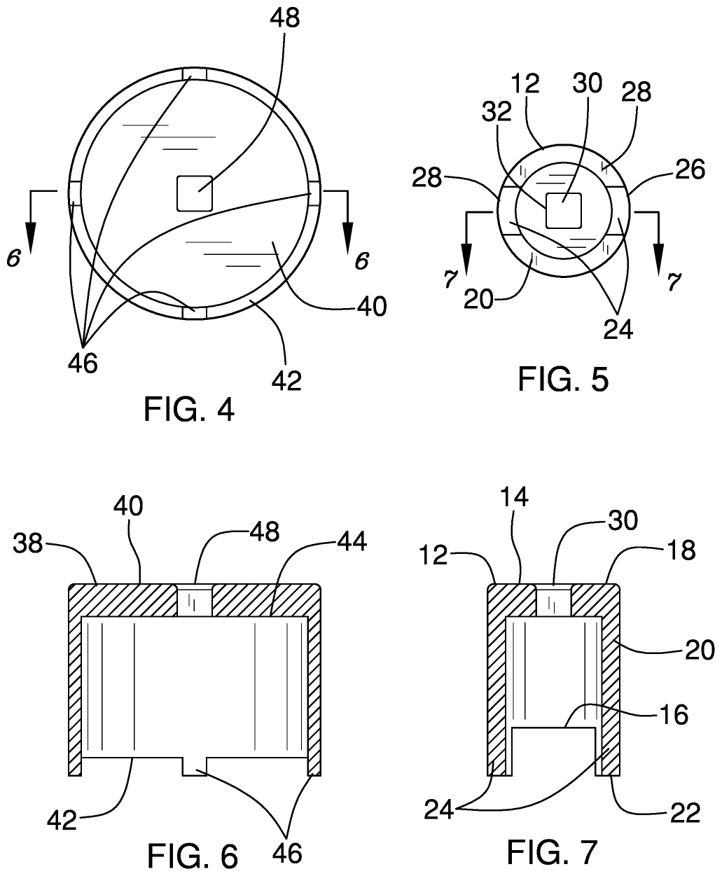

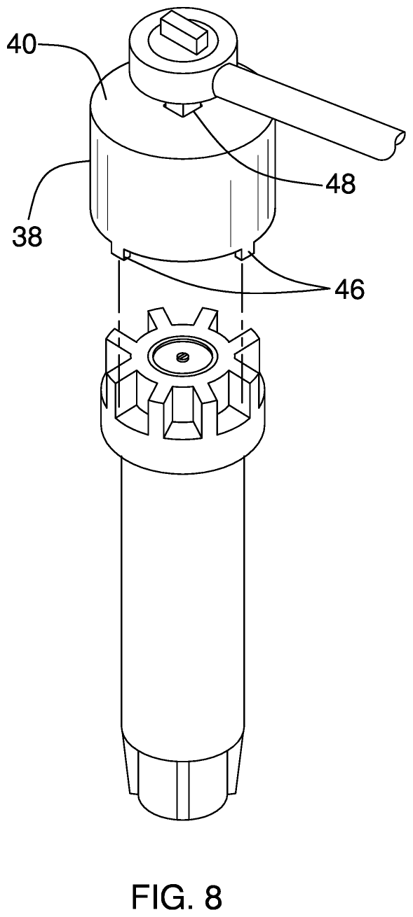

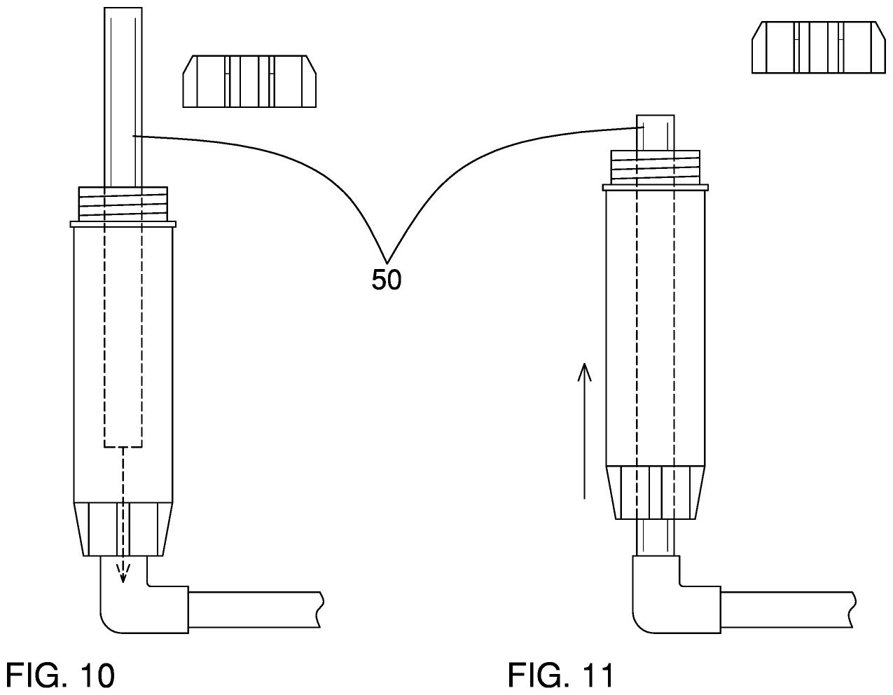

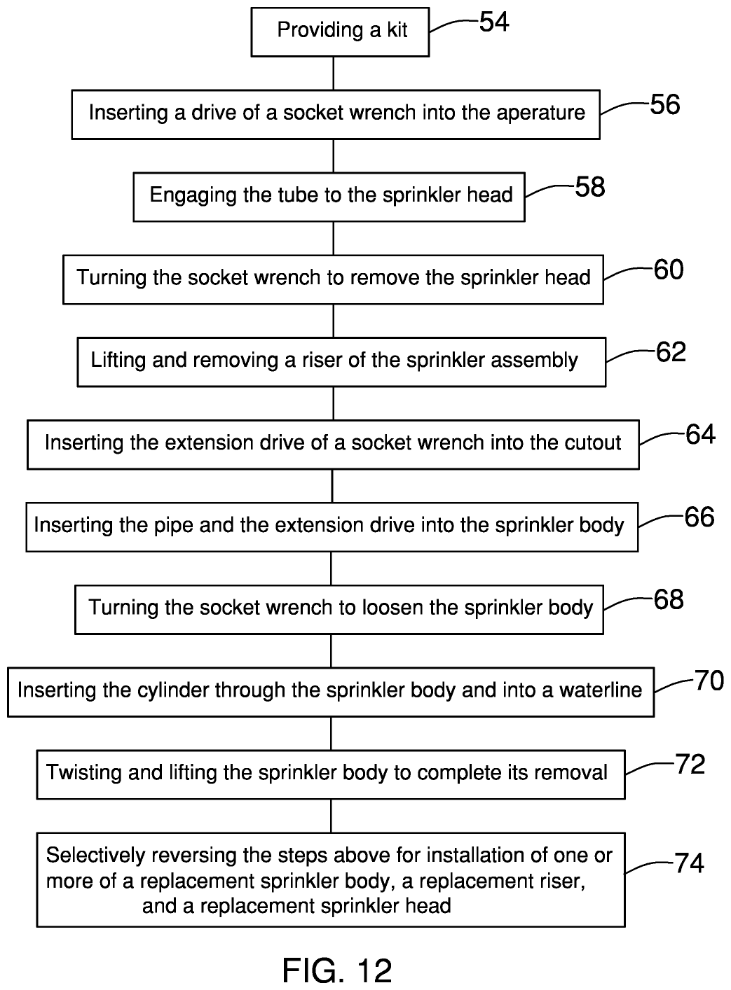

With reference now to the drawings, and in particular to FIGS. 1 through 12 thereof, a new removal and installation device embodying the principles and concepts of an embodiment of the disclosure and generally designated by the reference numeral 10 will be described.

As best illustrated in FIGS. 1 through 12, the sprinkler body removal and installation device 10 generally comprises a pipe 12 that has a first endpoint 14, which is closed, and a second endpoint 16, which is open. The pipe 12 has an outer diameter 18 that is complementary to a diameter of a set of furrows that is positioned on an inner face of a bottom of a sprinkler body.

The outer diameter 18 measures from 2.00 to 5.00 centimeters. The outer diameter 18 may measure 3.49 centimeters. The first endpoint 14 and the second endpoint 16 of the pipe 12 are separated by from 2.00 to 20.00 centimeters. The first endpoint 14 and the second endpoint 16 may be separated by 5.08 centimeters. A wall 20 of the pipe 12 has a thickness 22 of from 5.0 to 15.0 millimeters. The wall 20 of the pipe 12 may have a thickness 22 of 9.5 millimeters.

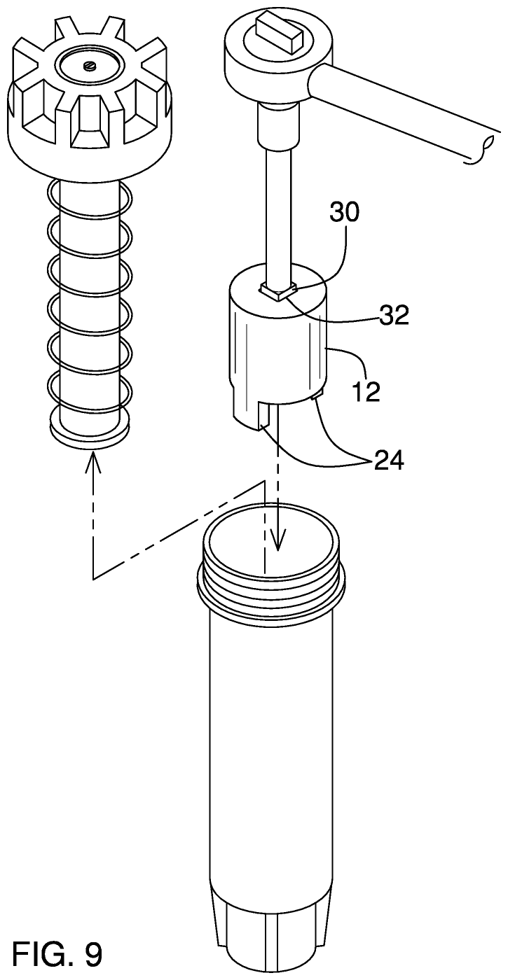

Each of a plurality of cogs 24 that is coupled to and extends from the second endpoint 16 of the pipe 12 is configured to be inserted into a respective furrow of the set of furrows as the pipe 12 is inserted into the sprinkler body, as is shown in FIG. 9.

The plurality of cogs 24 comprises from one to six cogs 24. The plurality of cogs 24 may comprise two cogs 24, which are opposing positioned on a perimeter 26 of the second endpoint 16 of the pipe 12 so that the cogs 24 are selectively positionable in opposingly positioned furrows.

Each cog 24 extends from 8.0 millimeters to 16.0 millimeters from the second endpoint 16 of the pipe 12. Each cog 24 may extend 12.7 millimeters from the second endpoint 16 of the pipe 12. Each cog 24 has a width 28 of 8.0 to 16.0 millimeters. Each cog 24 may have a width 28 of 12.7 millimeters.

The plurality of cogs 24 and the pipe 12 may comprise metal, or other rigid material, such as, but not limited to, plastic and the like. The plurality of cogs 24 and the pipe 12 may comprise stainless steel.

A cutout 30 that is centrally positioned in the first endpoint 14 of the pipe 12, as is shown in FIG. 5, is configured for insertion of an extension drive of a socket wrench, as is shown in FIG. 9. A user is positioned to selectively turn the socket wrench to remove and install the sprinkler body.

The cutout 30 is squarely shaped, with each side 32 of the cutout 30 measuring at least one of 6.3 millimeters, 9.5 millimeters, 12.5 millimeters, and 19.0 millimeters. Each side 32 of the cutout 30 may measure 9.5 millimeters.

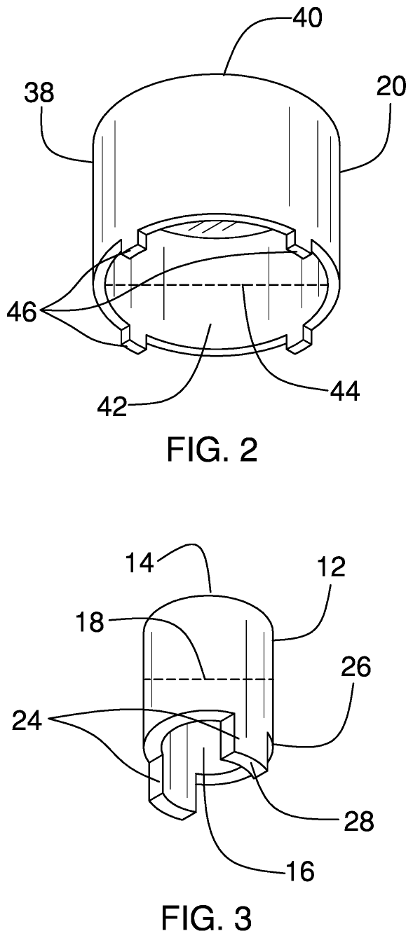

The present invention also anticipates a kit 34, as is shown in FIG. 1, comprising the sprinkler body removal and installation device 10 and a sprinkler body removal and installation device 36. The sprinkler body removal and installation device 36 comprises a tube 38, which has a first end 40, which is closed, as is shown in FIG. 1, and a second end 42 that is open, as is shown in FIG. 2.

The tube 38 has an inner diameter 44 that is complementary to a diameter of a set of grooves that is positioned in a top of a sprinkler head. Each of a plurality of teeth 46 is coupled to and extends from the second end 42 of the tube 38. The teeth 46 are configured to be inserted into a respective grooves of the set of grooves in as the top of a sprinkler head is partially inserted into the tube 38 through the second end 42. An aperture 48 that is centrally positioned in the first end 40 of the tube 38 is configured for insertion of a drive of a socket wrench, as is shown in FIG. 8, positioning the user to selectively turn the socket wrench to remove and install the sprinkler head.

The present invention also anticipates the kit 34 comprising a cylinder 46, which is shaped substantially complementarily to a riser of the sprinkler assembly. The cylinder 46 is configured to plug a waterline to which the sprinkler body is engaged to prevent introduction of debris into the waterline. Upon loosing of the sprinkler body with the sprinkler body removal and installation device 10, the cylinder 46 can be inserted through the sprinkler body and into the waterline. The sprinkler body then can be detached from the waterline without fear of debris entering the waterline.

In one example of a kit 34 that is anticipated to be particularly useful for removal and installation a Toro® brand sprinkler body, the sprinkler body removal and installation device 10 has an outer diameter 18 of 3.49 cm, the first endpoint 14 and the second endpoint 16 of the pipe 12 are separated by 5.08 cm, the wall has a thickness 22 of 9.5 mm, and two cogs 24 having a width of 12.7 mm are opposingly positioned on the perimeter 26 of the second endpoint 16 and extend 12.7 mm from the pipe 12. Different kits 34 can be assembled having pipes 12 and tubes 38 of a variety of dimensions and having cogs 24 and teeth 46, respectively, of a variety of dimensions and numbers, to accommodate a variety of sprinkler assemblies.

In use, the kit 34 enables a method 52 of removing and installing a sprinkler assembly. The method 52 comprising a first step 54 of providing a kit 34 according to the specification above. A second step 56 of the method 52 is inserting a drive of a socket wrench into the aperture 48. A third step 58 of the method 52 is engaging the tube 38 to the sprinkler head by aligning and inserting the teeth 46 into respective grooves of the set of grooves. A fourth step 60 of the method 52 is turning the socket wrench to remove the sprinkler head. A fifth step 62 of the method 52 is lifting and removing a riser of the sprinkler assembly.

A six step 64 of the method 52 is inserting an extension drive of a socket wrench into the cutout 30. A seventh step 66 of the method 52 is inserting the pipe 12 and the extension drive into the sprinkler body, so that each cog 24 is inserted into a respective furrow of the set of furrows. An eighth step 68 of the method 52 is turning the socket wrench to loosen the sprinkler body. A ninth step 70 of the method 52 is inserting the cylinder 50 into a waterline to which the sprinkler body is engaged to plug the waterline. A tenth step 72 of the method 52 is twisting and lifting the sprinkler body to complete its removal. An eleventh step 74 of the method 52 is selectively reversing the steps above to install of one or more of a replacement sprinkler body, a replacement riser, and a replacement sprinkler head.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sprinkler body removal and installation device comprising:
a pipe having a first endpoint and a second endpoint, the first endpoint being closed, the second endpoint being open, the pipe having an outer diameter complementary to a diameter of a set of furrows positioned on an inner face of a bottom of a sprinkler body of a sprinkler assembly;
a plurality of cogs coupled to and extending from the second endpoint of the pipe, wherein each cog is configured for inserting into a respective furrow of the set of furrows as the pipe is inserted into the sprinkler body; and
a cutout centrally positioned in the first endpoint of the pipe, wherein the cutout is configured for inserting an extension drive of a socket wrench, positioning a user for selectively turning the socket wrench for removing and installing the sprinkler body.

2. The sprinkler body removal and installation device of claim 1, further including the outer diameter measuring from 2.00 to 5.00 centimeters.

3. The sprinkler body removal and installation device of claim 2, further including the outer diameter measuring 3.49 centimeters.

4. The sprinkler body removal and installation device of claim 1, further including the first endpoint and the second endpoint of the pipe being separated by from 2.00 to 20.00 centimeters.

5. The sprinkler body removal and installation device of claim 4, further including the first endpoint and the second endpoint being separated by 5.08 centimeters.

6. The sprinkler body removal and installation device of claim 1, further including a wall of the pipe having a thickness of from 5.0 to 15.0 millimeters.

7. The device of claim 6, further including the wall of the pipe having a thickness of 9.5 millimeters.

8. The sprinkler body removal and installation device of claim 1, further including the plurality of cogs comprising from one to six cogs.

9. The sprinkler body removal and installation device of claim 8, further including the plurality of cogs comprising two cogs opposingly positioned on a perimeter of the second endpoint of the pipe, such that the cogs are selectively positionable in opposingly positioned furrows.

10. The sprinkler body removal and installation device of claim 1, further comprising:
each cog extending from 8.0 millimeters to 16.0 millimeters from the second endpoint of the pipe; and
each cog having a width of 8.0 to 16.0 millimeters.

11. The sprinkler body removal and installation device of claim 10, further comprising:
each cog extending 12.7 millimeters from the second endpoint of the pipe; and
each cog having a width of 12.7 millimeters.

12. The sprinkler body removal and installation device of claim 1, further including the plurality of cogs and the pipe comprising metal.

13. The sprinkler body removal and installation device of claim 12, further including the plurality of cogs and the pipe comprising stainless steel.

14. The sprinkler body removal and installation device of claim 1, further including the cutout being squarely shaped, each side of the cutout measuring one of 6.3 millimeters, 9.5 millimeters, 12.5 millimeters, and 19.0 millimeters.

15. The sprinkler body removal and installation device of claim 1, further comprising:
the outer diameter measuring 3.49 centimeters, the first end and the second end being separated by 5.08 centimeters, a wall of the pipe having a thickness of 9.5 millimeters;
the plurality of cogs comprising two cogs opposingly positioned on a perimeter of the second endpoint of the pipe, such that the cogs are selectively positionable in opposingly positioned furrows, each cog extending 12.7 millimeters from the second endpoint of the pipe, each cog having a width of 12.7 millimeters, the plurality of cogs and the pipe comprising stainless steel; and
the cutout being squarely shaped, each side of the cutout measuring 9.5 millimeters.

17. A sprinkler assembly removal and installation kit comprising:
a sprinkler head removal and installation device comprising:
a tube having a first end and a second end, the first end being closed, the second end being open, the tube having an inner diameter complementary to a diameter of a set of furrows positioned in a top of a sprinkler head of a sprinkler assembly,
a plurality of teeth coupled to and extending from the second end of the tube, wherein each tooth is configured for inserting into a respective groove of the set of grooves as the top of a sprinkler head is partially inserted into the tube through the second end, and
an aperture centrally positioned in the first end of the tube, wherein the aperture is configured for inserting a drive of a socket wrench positioning a user for selectively turning the socket wrench for removing and installing the sprinkler head; and
a sprinkler body removal and installation device comprising:
a pipe having a first endpoint and a second endpoint, the first endpoint being closed, the second endpoint being open, the pipe having an outer diameter complementary to a diameter of a set of furrows positioned on an inner face of a bottom of a sprinkler body of the sprinkler assembly,
a plurality of cogs coupled to and extending from the second endpoint of the pipe, wherein each cog is configured for inserting into a respective furrow of the set of furrows as the pipe is inserted into the sprinkler body, and
a cutout centrally positioned in the first endpoint of the pipe, wherein the cutout is configured for inserting an extension drive of the socket wrench positioning the user for selectively turning the socket wrench for removing and installing the sprinkler body.

18. The sprinkler assembly removal and installation kit of claim 17, further including a cylinder shaped substantially complementarily to a riser of the sprinkler assembly, wherein the cylinder is configured for insertion through the sprinkler body and into a waterline to which the sprinkler body is engaged for plugging the waterline for preventing introduction of debris into the waterline.

19. A method of removing and installing a sprinkler assembly, the method comprising the steps of:
providing a kit comprising:
a sprinkler head removal and installation device comprising:
a tube having a first end and a second end, the first end being closed, the second end being open, the tube having an inner diameter complementary to a diameter of a set of furrows positioned in a top of a sprinkler head of the sprinkler assembly,
a plurality of teeth coupled to and extending from the second end of the tube,
an aperture centrally positioned in the first end of the tube, and
a sprinkler body removal and installation device comprising:
a pipe having a first endpoint and a second endpoint, the first endpoint being closed, the second endpoint being open, the pipe having an outer diameter complementary to a diameter of a set of furrows positioned on an inner face of a bottom of a sprinkler body of the sprinkler assembly,
a plurality of cogs coupled to and extending from the second endpoint of the pipe, and
a cutout centrally positioned in the first endpoint of the pipe, and
a cylinder a shaped substantially complementarily to a riser of the sprinkler assembly;
inserting a drive of a socket wrench into the aperture;
engaging the tube to the sprinkler head by aligning and inserting the teeth into respective grooves of the set of grooves;
turning the socket wrench to remove the sprinkler head;
lifting and removing a riser of the sprinkler assembly;
inserting an extension drive of a socket wrench into the cutout;
inserting the pipe and the extension drive into the sprinkler body, such that each cog is inserted into a respective furrow of the set of furrows;
turning the socket wrench for loosening the sprinkler body;
inserting the cylinder through the sprinkler body and into a waterline to which the sprinkler body is engaged for plugging the waterline for preventing introduction of debris into the waterline;
twisting and lifting the sprinkler body to complete its removal; and
selectively reversing the steps above for installation of one or more of a replacement sprinkler body, a replacement riser, and a replacement sprinkler head.
